(19) United States
(12) Patent Application Publication
(10) Pub. No.: US 2024/0143241 A1
(43) Pub. Date: May 2, 2024

(54) STORAGE MEDIUM AND SETTING SYSTEM

(71) Applicant: CANON KABUSHIKI KAISHA, Tokyo (JP)

(72) Inventor: YOSHIHIRO TSUKADA, Ibaraki (JP)

(21) Appl. No.: 18/493,237

(22) Filed: Oct. 24, 2023

(30) Foreign Application Priority Data
Oct. 27, 2022 (JP) 2022-171910

(51) Int. Cl. G06F 3/12

(52) U.S. Cl. CPC G06F 3/1204; G06F 3/1231; G06F 3/1236; G06F 3/1253; G06F 3/1288; G06F 3/1293

(57) ABSTRACT

There is provided an information processing terminal for receiving a plurality of settings including a network setting of an image processing apparatus, transmitting the received network setting to the image processing apparatus, receiving, from the image processing apparatus, connection destination information to display a page on which at least a predetermined setting of the image processing apparatus that is different from the plurality of settings is to be configured, the connection destination information being generated based on the transmitted network setting, and displaying, based on completion of configuration of the plurality of settings, an object to access a connection destination indicated by the received connection destination information.

### BACKGROUND OF THE DISCLOSURE

### Field of the Disclosure

The present disclosure relates to a storage medium and a setting system.

### Description of the Related Art

Japanese Patent Application Laid-Open No. 2018-174367 discusses an application that is installed in a personal computer (PC) and executed to facilitate configuration of network settings of an image processing apparatus such as a multi-function peripheral (MFP).

To configure advanced settings of the MFP after the network settings are configured using the application, use of a remote user interface (remote UI) based on Hypertext Markup Language (HTML) data received from the MFP by accessing the MFP via Hypertext Transfer Protocol (HTTP) communication may be considered. In this case, a user identifies connection information such as an Internet Protocol (IP) address of the MFP and inputs the identified connection information to a web browser in order to display the remote UI. This is inconvenient for the user.

### SUMMARY OF THE INVENTION

The present disclosure is directed to reducing the burden on the user in configuring initial settings of the image processing apparatus.

According to an aspect of the present disclosure, a non-transitory computer-readable storage medium stores a program for causing an information processing terminal to execute a method comprising receiving a plurality of settings including a network setting of an image processing apparatus, transmitting the received network setting to the image processing apparatus, receiving, from the image processing apparatus, connection destination information to display a page on which at least a predetermined setting of the image processing apparatus that is different from the plurality of settings is to be configured, the connection destination information being generated based on the transmitted network setting, and displaying, based on completion of configuration of the plurality of settings, an object to access a connection destination indicated by the received connection destination information.

Further features of the present disclosure will become apparent from the following description of exemplary embodiments with reference to the attached drawings.

### BRIEF DESCRIPTION OF THE DRAWINGS

FIG. 1 is a diagram illustrating an example of a system configuration according to an aspect of the present disclosure.

FIG. 2 is a diagram illustrating an example of a hardware configuration of a multi-function peripheral (MFP).

FIG. 3 is a diagram illustrating an example of a hardware configuration of an information processing terminal.

FIG. 4 is a sequence diagram illustrating an example of a process of configuring initial settings of the MFP using a setup tool installed in the information processing terminal.

FIG. 5 is a flowchart illustrating an example of an initial setting configuration process executed by the information processing terminal.

FIGS. 6A and 6B are a flowchart illustrating an example of an initial setting configuration process executed by the MFP.

FIGS. 7A to 7D are diagrams illustrating an example of a setting screen of the setup tool.

FIG. 8 is a diagram illustrating an example of an initial setting screen.

FIG. 9 is a diagram illustrating an example of a scan setting screen.

FIG. 10 is a diagram illustrating an example of a password registration screen.

FIG. 11 is a diagram illustrating an example of an error screen.

FIG. 12 is a diagram illustrating an example of a password input screen.

### DESCRIPTION OF THE EMBODIMENTS

Various exemplary embodiments of the present disclosure will be described below with reference to the drawings. It is to be noted that configurations according to the exemplary embodiments described below are merely examples and the present disclosure is not limited to the illustrated configurations.

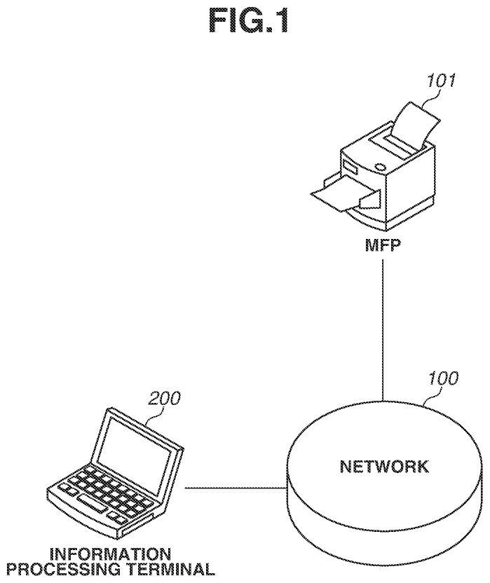

FIG. 1 is a diagram illustrating an example of a system configuration according to a first exemplary embodiment of the present disclosure. The system configuration according to the present exemplary embodiment includes an information processing terminal 200 and a multi-function peripheral (MFP) 101. The information processing terminal 200 is an example of a terminal apparatus, and the MFP 101 is an image processing apparatus capable of communicating with the information processing terminal 200 via a network 100. An application for configuring settings of the MFP 101 is installed in the information processing terminal 200 such as a personal computer (PC). The network 100 according to the present exemplary embodiment can be the Internet or a local area network (LAN). Further, the network 100 can be a wired network, a wireless network, or a network via the Internet. Further, the MFP 101 and the information processing terminal 200 can be connected together via a universal serial bus (USB) cable. In this case, the MFP 101 and the information processing terminal 200 each include a USB communication unit, and a USB cable is connected to the USB communication units to enable communication between the MFP 101 and the information processing terminal 200. Further, the MFP 101 and the information processing terminal 200 can be connected together via Direct Wireless communication.

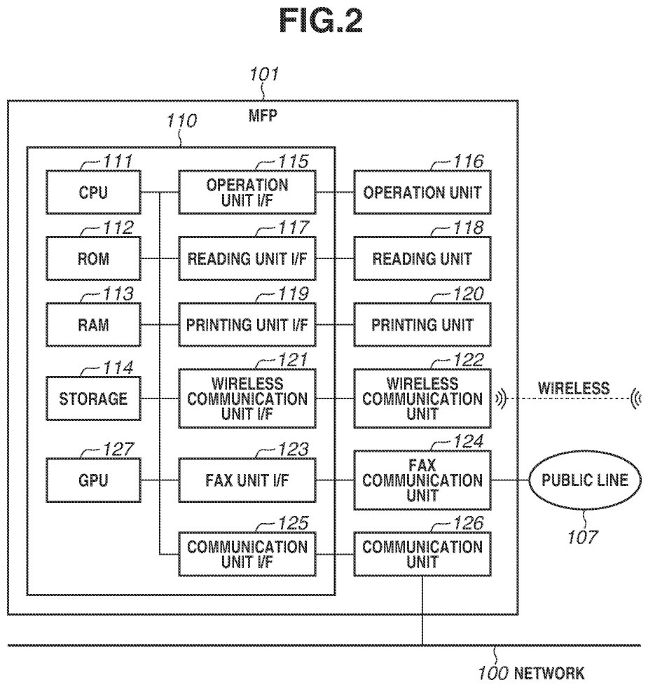

FIG. 2 is a diagram illustrating an example of a hardware configuration of the MFP 101. The MFP 101 includes a central processing unit (CPU) 111, a read-only memory (ROM) 112, a random access memory (RAM) 113, a storage 114, an operation unit interface (operation unit UF) 115, an operation unit 116, a reading unit interface (reading unit UF) 117, a reading unit 118, a printing unit interface (printing unit UF) 119, a printing unit 120, a wireless communication unit interface (wireless communication unit UF) 121, and a wireless communication unit 122. Further, the MFP 101 includes a fax unit interface (fax unit UF) 123, a fax communication unit 124, a communication unit interface (communication unit UF) 125, and a communication unit 126.

A control unit 110 including the CPU 111 controls operations of the entire MFP 101. The CPU 111 reads control programs stored in the ROM 112 or the storage 114 to the RAM 113 and performs various controls such as a reading control and a printing control. The ROM 112 stores control programs executable by the CPU 111. Further, the ROM 112 also stores a boot program and font data. The RAM 113 is a main storage memory and is used as a work area and a temporary storage area for loading various control programs stored in the ROM 112 and the storage 114. The storage 114 stores image data, print data, various programs, and various types of settings information. While it is intended to use a flash memory as the storage 114 according to the present exemplary embodiment, an auxiliary storage apparatus such as a solid state drive (SSD) or a hard disc drive (HDD) can be used. Further, an embedded multi-media card (eMMC) can be used.

While one CPU 111 executes processes illustrated in flowcharts described below using one memory (the RAM 113) in the MFP 101 according to the present exemplary embodiment, this is not a limiting configuration. For example, a plurality of CPUs, a plurality of RAMs, a plurality of ROMs, and a plurality of storages can cooperate together to execute the processes illustrated in the flowcharts described below. Further, part of the processes can be executed using a hardware circuit such as an application-specific integrated circuit (ASIC) or a field-programmable gate array (FPGA).

The operation unit OF 115 connects the control unit 110 and the operation unit 116 including a display unit such as a touch panel and hardware keys. The operation unit 116 displays information to the user and detects inputs from the user.

The reading unit OF 117 connects the control unit 110 and the reading unit 118 such as a scanner. The reading unit 118 reads a document image, and the CPU 111 converts the read image into image data such as binary data. The image data generated based on the image read by the reading unit 118 is transmitted to an external apparatus or is printed on a recording sheet.

The printing unit OF 119 connects the control unit 110 and the printing unit 120 such as a printer. The CPU 111 transfers image data (print data) stored in the RAM 113 to the printing unit 120 via the printing unit I/F 119. The printing unit 120 prints an image based on the transferred image data on a recording sheet fed from a sheet feed cassette.

The wireless communication unit OF 121 is an interface for controlling the wireless communication unit 122 and wirelessly connects the control unit 110 and an external wireless device (the information processing terminal 200 here).

The control unit 110 is connected to a public line 107 by controlling the fax communication unit 124 such as a facsimile machine via the fax unit OF 123. The fax unit OF 123 is an interface for controlling the fax communication unit 124 and performs a connection to the public line 107 and a facsimile communication protocol control by controlling a modem for facsimile communication and a network control unit (NCU). The communication unit OF 125 connects the control unit 110 and the network 100. The communication unit 126 transmits image data and various types of information in the apparatus to an external apparatus on the network 100 and receives print data and information on the network 100 from an information processing apparatus on the network 100 by the communication unit OF 125. The transmission and reception via the network 100 can be performed using a method that uses an electronic mail or a file transmission method using another protocol (e.g., File Transfer Protocol (FTP), Server Message Block (SMB), Web-based Distributed Authoring and Versioning (WEBDAV)). Furthermore, image data and various types of settings data can be transmitted and received via the network 100 from the information processing terminal 200 using Hypertext Transfer Protocol (HTTP) communication.

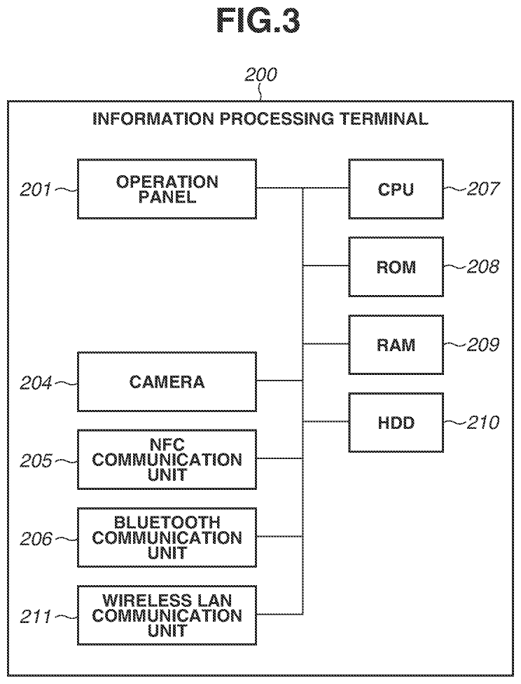

FIG. 3 is a diagram illustrating an example of a hardware configuration of the information processing terminal 200. While it is intended to use an apparatus such as a smartphone, a tablet, or a PC as the information processing terminal 200 according to the present exemplary embodiment, another information processing apparatus capable of communicating with the MFP 101 can be used.

A CPU 207 reads control programs stored in a ROM 208 and performs various types of processing to control operations of the information processing terminal 200. The ROM 208 stores control programs. A RAM 209 is a main memory of the CPU 207 and is used as a work area and a temporary storage area. An HDD 210 stores various kinds of data such as images and electronic documents.

An operation panel 201 includes a touch panel function of detecting touch operations by the user and displays various screens provided by an operating system (OS) or an email transmission application. Further, the operation panel 201 is used to execute a setup tool. The setup tool is an initial setting application of the MFP 101. The user can input an intended operation instruction to the information processing terminal 200 by inputting a touch operation to the operation panel 201. The information processing terminal 200 may include hardware keys (not illustrated), and the user can input operation instructions to the information processing terminal 200 using the hardware keys.

A camera 204 captures images based on imaging instructions from the user. Images captured by the camera 204 are stored in a predetermined area of the HDD 210. Further, information can be acquired from a QR Code® read by the camera 204 using a program capable of analyzing QR codes.

The information processing terminal 200 can exchange data with various peripheral devices via a near-field communication (NFC) communication unit 205, a Bluetooth® communication unit 206, and a wireless LAN communication unit 211. The Bluetooth® communication unit 206 of the information processing terminal 200 can support Bluetooth® Low Energy.

The setup tool of the MFP 101 is installed (stored) in a predetermined area of the HDD 210. The setup tool is loaded to the RAM 209 and executed.

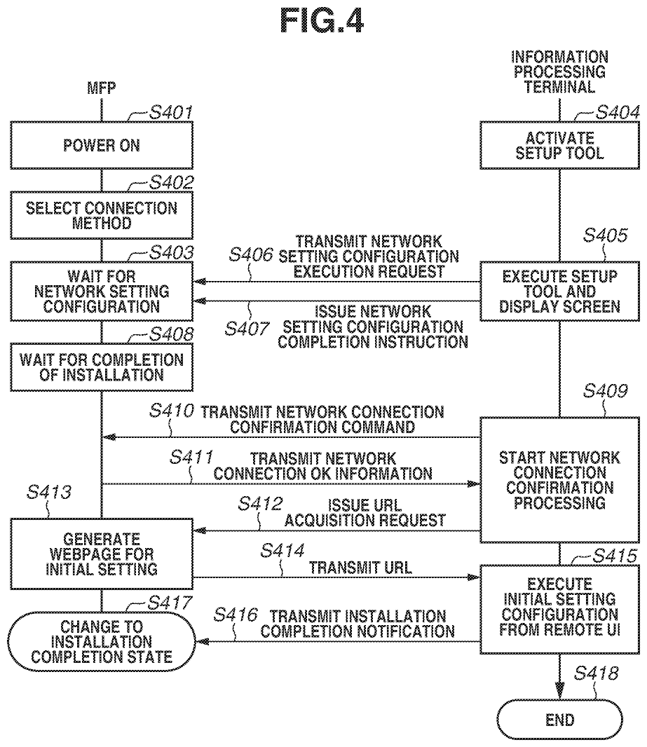

FIG. 4 is a sequence diagram illustrating an example of a process of configuring initial settings of the MFP 101 using the setup tool installed in the information processing terminal 200.

In step S401, the MFP 101 is activated in a case where a power ON instruction is received from the user. In step S402, the MFP 101 displays a connection method selection screen on the operation unit 116. On the connection method selection screen, a method for connecting the MFP 101 and the information processing terminal 200 can be selected from USB connection, wired LAN connection, wireless LAN connection (infrastructure connection), and Wireless Direct connection.

In step S403, the MFP 101 changes to a network setting configuration waiting state in the selected connection method. Specifically, whether a network setting configuration start command is received via an interface corresponding to the selected connection method is determined. For example, in a case where the USB connection is selected on the connection method selection screen, the CPU 111 of the MFP 101 determines whether a network setting configuration start command is received via the USB communication unit of the MFP 101.

In step S404, the information processing terminal 200 activates the setup tool, which is an initial setting application of the MFP 101, based on a user operation.

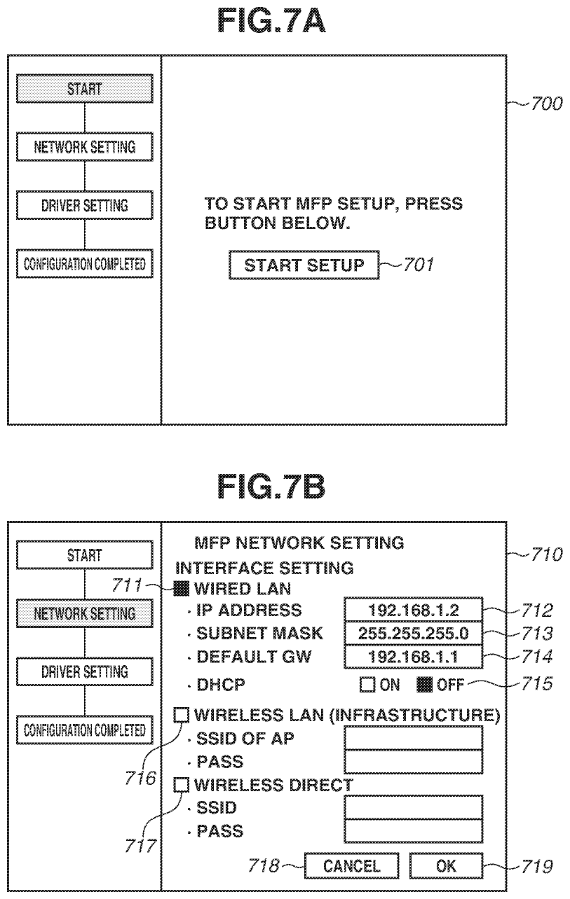

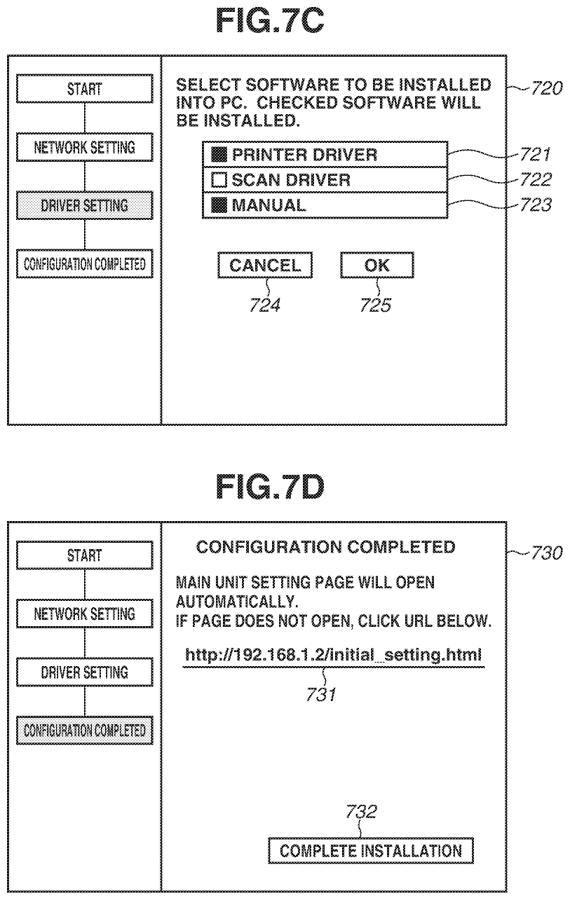

In step S405, the information processing terminal 200 executes the setup tool and displays a screen of the setup tool on the operation panel 201. In a case where a network setting configuration start instruction is received via the screen, in step S406, a network setting configuration execution request is transmitted to the MFP 101. Specifically, the network setting configuration and software installation are performed based on settings input via setting screens 700 to 730 in FIGS. 7A to 7D.

FIGS. 7A to 7D are diagrams illustrating an example of a setting screen of the setup tool. The setting screens 700 to 730 in FIGS. 7A to 7D are screens that are displayed on the operation panel 201 in a case where the CPU 207 of the information processing terminal 200 activates the setup tool.

FIG. 7A is a diagram illustrating the start screen 700 of the setup tool. On the start screen 700, a start button 701 is displayed, and in a case where the start button 701 is selected, the setup (initial setting) processing is started.

FIG. 7B is a diagram illustrating an example of the network setting configuration screen 710 of the setup tool. The network setting configuration screen 710 is displayed in a case where the start button 701 is selected, and on the network setting configuration screen 710, interface settings of the MFP 101 can be configured. A communication function to be enabled on the MFP 101 can be selected using buttons 711, 716, and 717 on the network setting configuration screen 710. In the examples in FIGS. 7A to 7D, a wired LAN function is enabled. A wireless LAN function and a Wireless Direct function can be configured not to be enabled while the wired LAN function is enabled, or desired functions can be allowed to be enabled simultaneously.

An input field 712 is an input field for inputting an Internet Protocol (IP) address of the MFP 101 in wired connection. An input field 713 is an input field for inputting a subnet mask of the MFP 101 in wired connection. An input field 714 is an input field for inputting the IP address of the MFP 101 in wired connection. A setting button 715 is a button for enabling or disabling a Dynamic Host Configuration Protocol (DHCP) function. In FIGS. 7A to 7D, the DHCP function is set to OFF. In a case where the DHCP function is set to ON using the setting button 715, setting values input to the input fields 712 to 714 become invalid and cannot be corrected. In a case where a cancel button 718 is selected, the setup tool cancels the network setting configuration. In a case where an OK button 719 is selected, the setup tool stores the input setting values in the HDD 210 of the information processing terminal 200 and transmits, to the MFP 101, the setting values input to the setting screen 710 as network setting information. At this time, the information processing terminal 200 (setup tool) can transmit the setting values via USB communication or via wired or wireless LAN communication.

FIG. 7C is a diagram illustrating an example of the software setting screen 720 of the setup tool. The software setting screen 720 is displayed in a case where the OK button 719 is selected. The software setting screen 720 is a screen for selecting software to be installed into the information processing terminal 200. On the software setting screen 720, buttons 721 to 723 are displayed. The button 721 is a button for installing a printer driver supported by the MFP 101. The button 722 is a button for installing a scan driver supported by the MFP 101. The button 723 is a button for downloading a manual of the MFP 101. In a case where an OK button 725 is selected with at least one of the buttons 721 to 723 being selected, software corresponding to the selected button is installed (downloaded) into the information processing terminal 200. In a case where a cancel button 724 is selected, the software configuration is cancelled.

FIG. 7D is a diagram illustrating an example of the setting completion screen 730 of the setup tool. The setting completion screen 730 is displayed in a case where the OK button 725 is selected. On the setting completion screen 730, a link 731 is displayed. In a case where the link 731 is selected, a web browser installed in the information processing terminal 200 is activated and accesses the URL “http:192.168.1.2/Jinitial_setting.html” corresponding to the link 731. The link 731 can be an object such as a button. Further, the setup tool can activate the web browser installed in the information processing terminal 200 and can prompt the web browser to access the connection destination URL corresponding to the link 731 based on the selection of the OK button 725 without selection of the link 731 by the user. A trigger to display the setting completion screen 730 and/or a trigger to prompt the web browser to access the URL can be the selection of the OK button 719 or the timing of the completion of the network setting configuration of the MFP 101. Whether the network setting configuration of the MFP 101 is completed is determined based on whether the information processing terminal 200 has received a network setting configuration completion notification from the MFP 101.

As described above, in step S406, the setting values configured on the network setting configuration screen 710 are transmitted from the information processing terminal 200 to the MFP 101. The MFP 101 performs the network setting configuration based on the received setting values.

In step S407, the information processing terminal 200 issues a network setting configuration completion instruction to the MFP 101. Consequently, the MFP 101 changes from the network setting configuration waiting state to a normal state. In step S408, the MFP 101 changes to an initial installation completion waiting state.

In step S409, the information processing terminal 200 starts network connection confirmation processing on the MFP 101. In step S410, the information processing terminal 200 executes the setup tool, transmits a Ping command to the IP address configured on the network setting configuration screen 710, and checks whether there is a response. In step S411, the MFP 101 transmits connection OK information to the information processing terminal 200, which is the transmitter of the connection confirmation. The network connection confirmation in step S409 can be executed using a protocol such as Simple Network Management Protocol (SNMP).

In step S412, after confirming that the network connection has been established, the information processing terminal 200 issues, to the MFP 101, a request to acquire a URL of an initial setting page (remote UI). The URL to be acquired here includes the IP address configured on the network setting configuration screen 710 by the user. This enables access to the remote UI of the MFP 101 after the configuration of the initial settings of the network settings is ended. Instead of acquiring the URL from the MFP 101, the setup tool can store the setting values input on the network setting configuration screen 710. In this case, the setup tool activates the web browser and prompts the web browser to access the stored IP address. Consequently, a top page of the remote UI of the MFP 101 is displayed to jump to an initial setting page automatically.

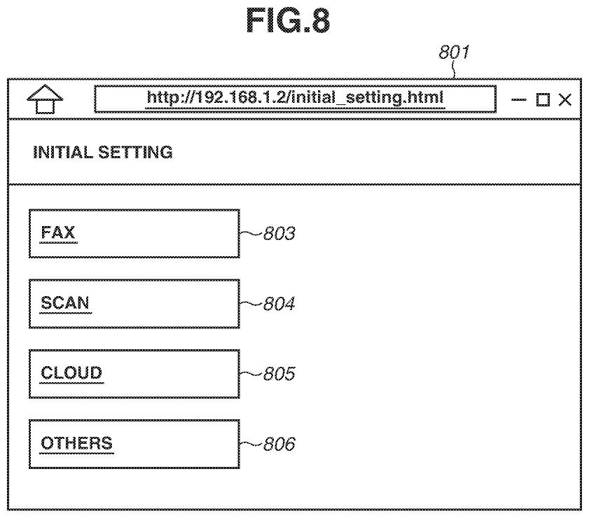

In step S413, the MFP 101 generates an initial setting webpage (remote UI). The webpage includes Hypertext Markup Language (HTML), Cascading Style Sheets (CSS), Java script, and image files. In step S414, the MFP 101 transmits a URL of the generated webpage to the information processing terminal 200, which is the transmitter of the request. The URL transmitted here is a URL for displaying an initial setting screen 801 in FIG. 8 described below.

In step S415, the link 731 is generated based on the URL received in step S414, and the setting completion screen 730 is displayed on the operation panel 201 of the information processing terminal 200. Then, the information processing terminal 200 receives selection of the link 731 on the setup tool, activates the web browser, and accesses the transmitted URL. Then, the web browser on the information processing terminal 200 receives various initial settings. The received initial settings are transmitted from the information processing terminal 200 to the MFP 101, and the MFP 101 configures the setting values. In a case where an initial setting configuration completion instruction is issued by the user, an installation completion notification is transmitted from the information processing terminal 200 to the MFP 101 in step S416. In step S417, the MFP 101 changes to an installation completion state based on the notification transmitted in step S416. This causes normal activation processing instead of the initial installation flow to be performed at the next power-on of the MFP 101. Further, the initial installation completion waiting state of the MFP 101 can be changed to a completion state as time passes without an instruction from the user. In step S418, the information processing terminal 200 ends the setup tool.

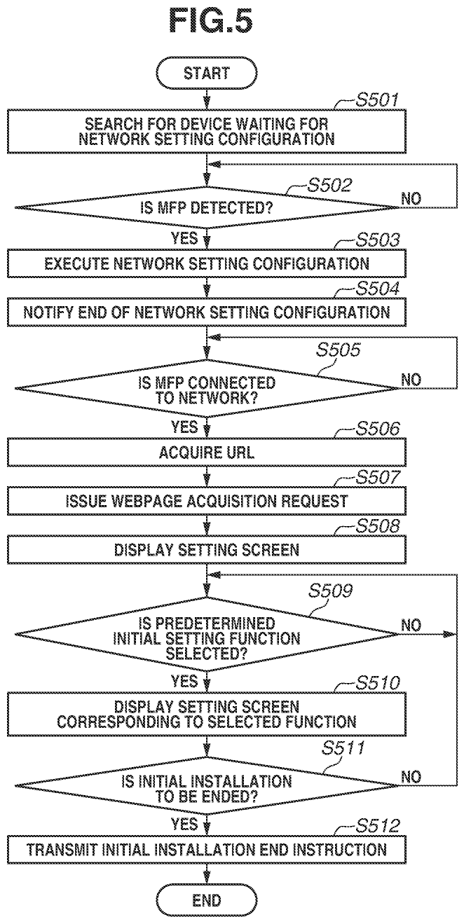

FIG. 5 is a flowchart illustrating an example of an initial setting configuration process that is executed by the information processing terminal 200. The process in the flowchart in FIG. 5 is executed in a case where the CPU 207 reads the setup tool or a program such as the web browser stored in the ROM 208 to the RAM 209 and executes the read setup tool or program.

In step S501, the setup tool searches for a device waiting for network setting configuration.

The search can be performed via USB communication or can be performed via wired LAN, wireless LAN, or Wireless Direct communication.

In step S502, the setup tool determines whether an MFP is detected by the search. In a case where the setup tool determines that an MFP is detected (YES in step S502), the processing proceeds to step S503. Otherwise (NO in step S502), the processing returns to step S502.

In step S503, the setup tool executes the network setting configuration. Specifically, the start screen 700 is displayed based on the detection of the MFP in step S502. In a case where the start button 701 is selected on the start screen 700, the network setting configuration screen 710 is displayed. On the network setting configuration screen 710, inputs of a communication function (wired LAN, wireless LAN, Wireless Direct) of the MFP 101 that is to be enabled and a setting value corresponding to the function are received. Then, the information processing terminal 200 transmits the input setting value to the MFP 101.

In step S504, the setup tool notifies the MFP 101 that the network setting configuration is ended.

In step S505, the setup tool performs network connection confirmation on the MFP 101. In a case where there is a network response (YES in step S505), the processing proceeds to step S506. Otherwise (NO in step S505), the setup tool waits in step S505.

In step S506, the setup tool transmits a URL acquisition request to the MFP 101 and receives, from the MFP 101, the URL for displaying the initial setting webpage generated by the MFP 101.

In step S507, the setup tool issues a webpage acquisition request to the acquired URL and receives the webpage (e.g., HTML file) from a web server in the MFP 101. A locale name indicating the initial setting screen can be provided to the URL. The URL to which the webpage acquisition request is to be transmitted here can be a URL generated by the setup tool. In this case, the webpage acquisition request is transmitted to the URL generated based on the IP address input to the network setting configuration screen 710.

In step S508, the setup tool activates the web browser, and the web browser displays the webpage acquired from the MFP 101 on the operation panel 201. Specifically, the initial setting screen 801 in FIG. 8 is displayed on the web browser. On the initial setting screen 801, a fax button 802, a scan button 803, a cloud button 804, and an others button 805 are displayed.

In step S509, the web browser receives selection of an initial setting configuration target function from the user, and in a case where a predetermined initial setting function is selected by the user (YES in step S509), the processing proceeds to step S510. Otherwise (NO in step S509), the web browser waits in step S509.

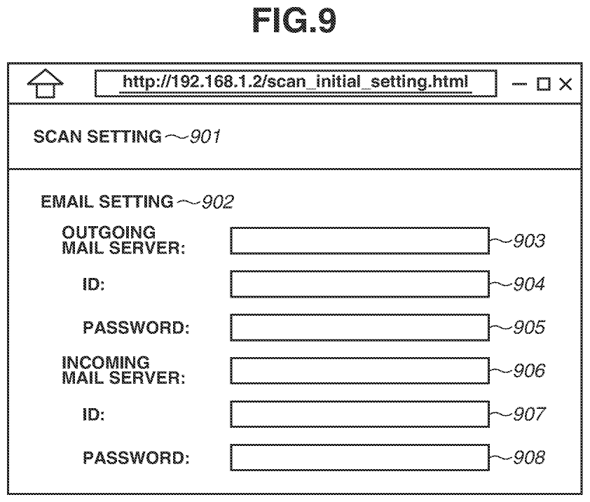

In step S510, the setup tool displays an initial setting screen corresponding to the function selected by the user. A fax setting screen (not illustrated) is displayed in a case where the fax button 802 is selected. A scan setting screen 901 in FIG. 9 is displayed in a case where the scan button 803 is selected. A cloud setting screen (not illustrated) is displayed in a case where the cloud button 804 is selected. A setting screen related to other functions of the MFP 101 is displayed in a case where the others button 805 is selected.

The scan setting screen 901 in FIG. 9 is a screen that is displayed on the operation panel 201 of the information processing terminal 200. Especially a setting item 902 related to an email function is displayed in FIG. 9. On the scan setting screen 901, an input field 903 for inputting a host name of an outgoing mail server (Simple Mail Transfer Protocol (SMTP) server), an input field 904 for inputting an identifier (ID) for use in authentication on the server, and an input field 905 for inputting a password are displayed. Furthermore, an input field 906 for inputting a host name of an incoming mail server (Post Office Protocol (POP) server), an input field 907 for inputting an ID for use in authentication on the server, and an input field 908 for inputting a password are also displayed. As described above, settings of a function (email transmission, FTP transmission, SMB transmission) of transmitting, by the communication unit 126, image data generated by scanning a document by the reading unit 118 of the MFP 101 and the scan function can be configured on the scan setting screen 901. Then, the setting values input to the scan setting screen 901 are transmitted from the information processing terminal 200 to the MFP 101 via HTTP communication.

In step S511, the web browser prompts the user to select to either change to a top screen of the initial settings or end the initial installation. In a case where the user selects to end the initial installation (YES in step S511), the processing proceeds to step S512. Otherwise (NO in step S511), the processing returns to step S509. This screen transition is executed by the web browser of the information processing terminal 200 by communicating with the web server of the MFP 101.

In step S512, the web browser transmits an initial installation end instruction to the MFP 101.

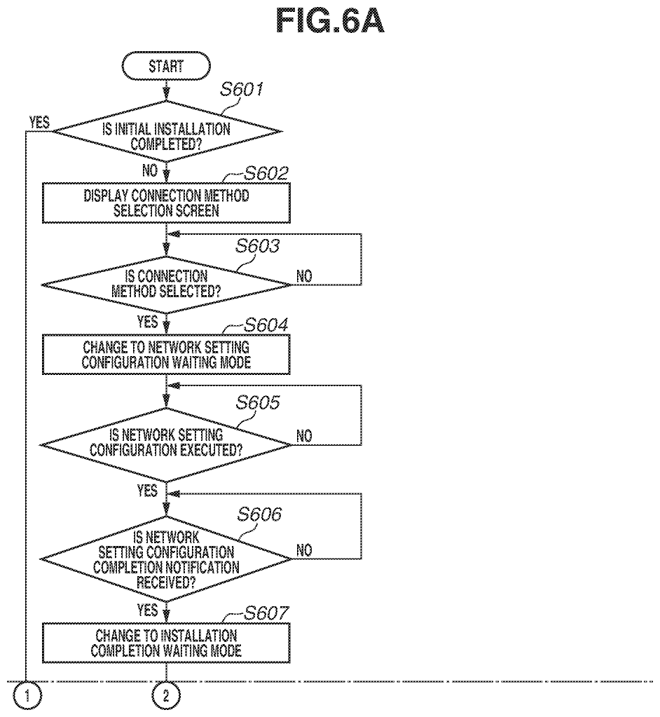

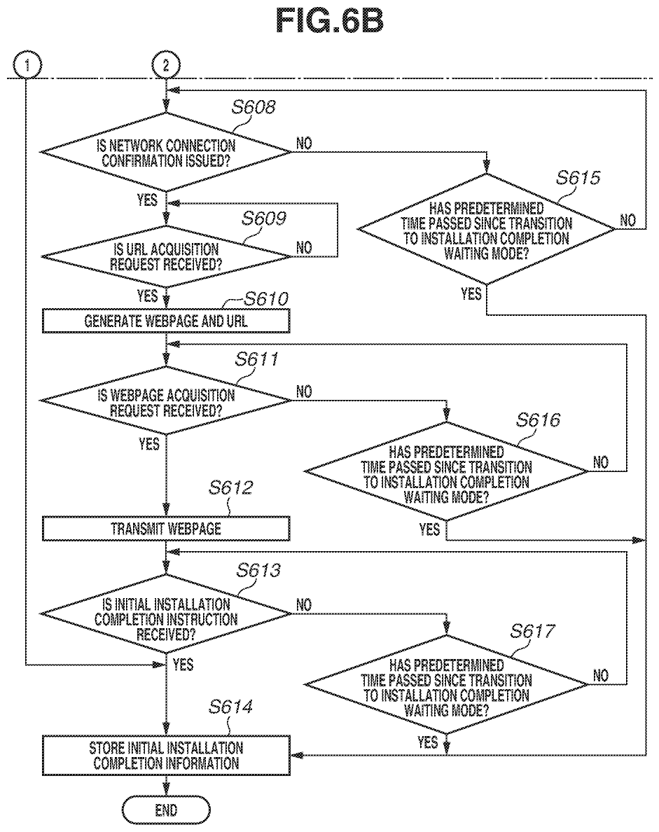

FIGS. 6A and 6B are a flowchart illustrating an example of an initial setting configuration process that is executed by the MFP 101.

The process in the flowchart in FIGS. 6A and 6B is executed in a case where the CPU 111 reads a program stored in the ROM 112 to the RAM 113 and executes the read program.

In step S601, the MFP 101 checks information stored in the storage 114 and indicating whether the initial installation is completed. In a case where the initial installation is not completed (NO in step S601), the processing proceeds to step S602. Otherwise (YES in step S601), the processing returns to step S614.

In step S602, the MFP 101 displays the connection method selection screen on the operation unit 116. In step S603, the MFP 101 determines whether a connection method is selected. In a case where the MFP 101 determines that a connection method is selected (YES in step S603), the processing proceeds to step S604. Otherwise (NO in step S603), the processing returns to step S603.

In step S604, the MFP 101 changes to a network setting configuration waiting mode. In step S605, the MFP 101 determines whether the network setting reception and the network setting configuration are executed. In a case where the MFP 101 determines that the network setting configuration is executed (YES in step S605), the processing proceeds to step S606. Otherwise (NO in step S605), the processing returns to step S605. The setting values configured on the network setting configuration screen 710 are received here from the information processing terminal 200. In a case where the network setting reception is executed (YES in step S605), the processing proceeds to step S606. Otherwise (NO in step S605), the processing waits in step S605.

In step S606, the MFP 101 waits until a network setting configuration completion notification is received. In a case where a network setting configuration completion notification is received (YES in step S606), the processing proceeds to step S607. Otherwise (NO in step S606), the MFP 101 waits in step S606. In step S607, the MFP 101 changes to an installation completion waiting mode. In step S608, the MFP 101 waits for a network connection confirmation. In a case where a network connection confirmation is issued (YES in step S608), the MFP 101 responds, and the processing proceeds to step S609. Otherwise (NO in step S608), the processing proceeds to step S615.

In step S609, the MFP 101 determines whether a URL acquisition request is received. In a case where the MFP 101 determines that a URL acquisition request is received (YES in step S609), the processing proceeds to step S610. Otherwise (NO in step S609), the processing returns to step S609.

In step S610, the MFP 101 generates a webpage based on the URL acquisition request and generates a URL of the generated webpage. The webpage can be generated in advance.

In step S611, the MFP 101 determines whether a webpage acquisition request is received via the communication unit 126. Specifically, whether the URL generated in step S610 has been accessed via HTTP communication is determined. In a case where an acquisition request is received (YES in step S611), the processing proceeds to step S612. Otherwise (NO in step S611), the processing proceeds to step S616.

In step S612, the MFP 101 transmits a webpage (e.g., HTML file) using a HTTP POST method to the information processing terminal 200, which is the transmitter of the webpage acquisition request, via the communication unit 126.

In step S613, the MFP 101 determines whether an initial installation completion instruction is received. In a case where the MFP 101 determines that an initial installation completion instruction is received (YES in step S613), the processing proceeds to step S614. Otherwise (NO in step S613), the processing proceeds to step S617.

In step S614, the MFP 101 stores, in the storage 114, information indicating that the initial installation is completed. In step S615, the MFP 101 determines whether a predetermined time has passed since the transition to the installation completion waiting mode in step S607. In a case where the MFP 101 determines that the predetermined time has passed (YES in step S615), the processing proceeds to step S614. Otherwise (NO in step S615), the processing returns to step S608. In step S616, the MFP 101 determines whether a predetermined time has passed since the transition to the installation completion waiting mode in step S607. In a case where the MFP 101 determines that the predetermined time has passed (YES in step S616), the processing proceeds to step S614. Otherwise (NO in step S616), the processing returns to step S611. In step S617, the MFP 101 determines whether a predetermined time has passed since the transition to the installation completion waiting mode in step S607. In a case where the MFP 101 determines that the predetermined time has passed (YES in step S617), the processing proceeds to step S614. Otherwise (NO in step S617), the processing returns to step S613. The predetermined times in steps S615, S616, and S617 can be the same time or different times.

By executing the above-described processes, burden on the user in configuring the initial settings of the image processing apparatus is reduced. Further, by setting the advanced settings on the screen received from the web server of the MFP 101 as in the present case, provision of different tools for different models with advanced settings different from each other is rendered unnecessary. Further, installation of a plurality of setup tools in performing a setup of an optional apparatus or a plurality of models with different setting items by the user is also rendered unnecessary. The link 731 displayed on the setting completion screen 730 can be in any form that prompts the user to access the remote UI. For example, a button with the message “Continue the setup on the remote UI” displayed thereon can be used, or simply a URL can be displayed. Further, the setup tool can activate the web browser and prompt the web browser to access the acquired URL based on the completion of the network setting configuration without a user operation. Further, there are users unaware that the settings of the MFP 101 that are different from the network settings can be configured on the remote UI of the MFP 101, and such users can be prompted to access the remote UI.

Further, in the above-described examples according to the present exemplary embodiment, in a case where the network setting configuration and the setting configuration of software to be installed are completed, the link to access the remote UI is displayed, or the web browser is automatically activated and the initial setting screen is displayed. The present disclosure is not limited to those described above, and a screen (initial setting screen 801) for configuring the next setting can be displayed based on the completion of the configuration of the settings on the setup tool by the user. Specifically, the setting completion screen 730 can be displayed in a case where the setup tool determines that the configuration of a plurality of settings (e.g., network settings, software settings) that can be configured on the setup tool is completed. Furthermore, the setup tool can activate the web browser and prompt the web browser to display the initial setting screen 801 in a case where the setup tool determines that the configuration of the plurality of settings is completed. Further, the web browser can be activated automatically and prompted to display the initial setting screen 801 before the configuration of the plurality of settings that can be set on the setup tool is completed (e.g., after only the network setting configuration is completed). The completion of the configuration of the plurality of settings here includes a case where there are the network setting configuration and the software setting configuration and an instruction to skip the software setting configuration and proceed to the next processing is issued.

A password to permit access to a webpage is configured on the MFP 101 that is for use in a high-security office. At the time of configuring the initial settings, no password has been set. Thus, in a case where the remote UI of the MFP 101 is accessed for the first time by a user, the user may be prompted to configure a password. However, since anyone with the knowledge of the IP address of the MFP 101 or the URL of the webpage can access the webpage, there is a possibility that a malicious user configures a password. The present exemplary embodiment is directed to preventing unintended users from configuring a password to access a webpage provided by an MFP.

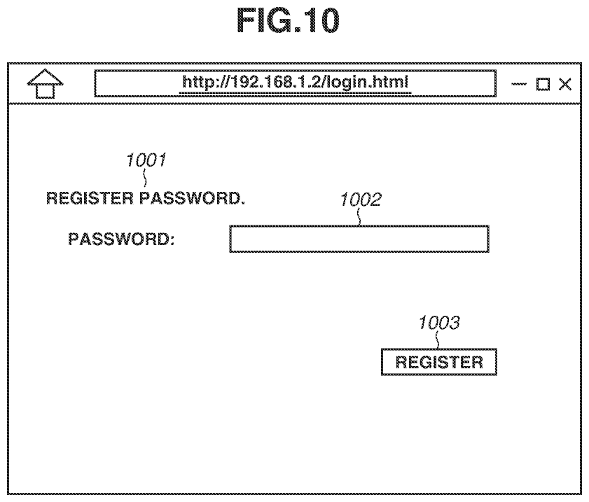

FIG. 10 is a diagram illustrating an example of a password registration screen 1001 for registering a password. The password registration screen 1001 is a webpage provided by the MFP 101. This screen illustrates the web browser displayed on the operation panel 201 by the information processing terminal 200. In conventional cases, the password registration screen 1001 in FIG. 10 is displayed in a case where the webpage of the MFP 101 is accessed for the first time. The password registration screen 1001 is displayed whenever accessed for the first time regardless of the timing of the access. Thus, in a case where an administrator user leaves the webpage without registering a password, another user having accessed the webpage is able to configure a password without permission. According to the present exemplary embodiment, timings to display the password registration screen 1001 are limited to impede configuration of a password by unintended users. A specific example thereof will be described below.

According to the present exemplary embodiment, the webpage of the password registration screen 1001 is transmitted to the information processing terminal 200 before the webpage of the initial setting screen 801 is transmitted in step S612 of the flow in FIG. 6B.

On the password registration screen 1001, an input field 1002 for inputting a password by the user and a register button 1003 are displayed. In a case where the user inputs a password and selects the register button 1003, the input password is transmitted from the information processing terminal 200 to the MFP 101. Then, the MFP 101 stores the received password in the storage 114, and from the next access to the remote UI and thereafter, the MFP 101 receives an input of the stored password.

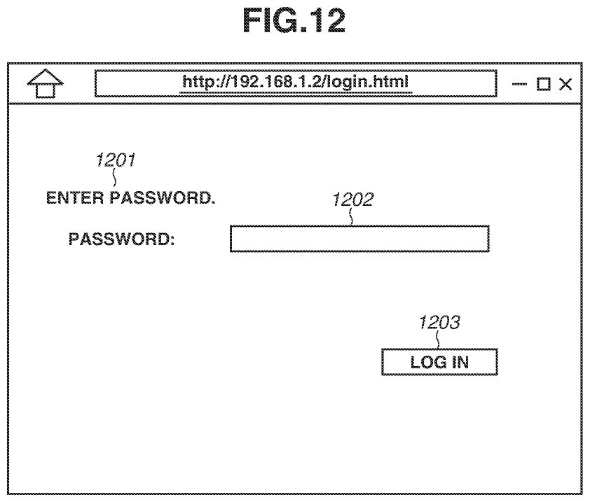

Specifically, a login screen 1201 in FIG. 12 is transmitted to the information processing terminal 200 and is displayed on the information processing terminal 200. On the login screen 1201, a password input field 1202 and a login button 1203 are displayed. In a case where the password registered on the password registration screen 1001 is input to the password input field 1202 and the login button 1203 is selected, various settings can be configured on the remote UI. Unless the password is input, the user cannot configure the various settings on the remote UI.

In a case where the register button 1003 is selected by the user, the processing of step S612 in FIG. 6B is executed. Specifically, the MFP 101 transmits the webpage of the initial setting screen 801 to the information processing terminal 200 and receives various settings. The process thereafter is similar to the flow in FIGS. 6A and 6B.

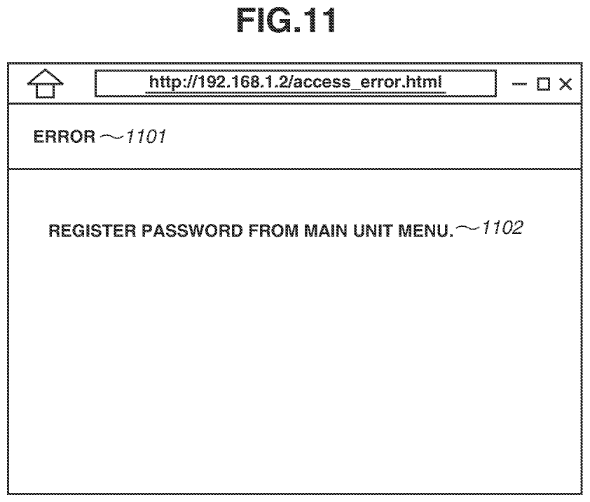

The password registration screen 1001 is displayed only during the installation completion waiting mode in step S607 of the flow in FIG. 6A. After the transition from the installation completion waiting mode to an initial installation completion state, the password registration screen 1001 is not displayed even in a case where the remote UI of the MFP 101 is accessed for the first time. For example, in a case where the predetermined time passes without a web acquisition instruction from the user in step S611 and the transition to the initial installation completion state is made in step S614, it becomes a situation where no users have accessed the remote UI. During this situation, configuration of a password by a user other than the administrator performing the initial installation is prevented. In a case where the remote UI is accessed for the first time while the MFP 101 is in a state that is not the installation completion waiting mode, a webpage of an error screen 1101 in FIG. 11 is transmitted to the information processing terminal 200 and is displayed on the information processing terminal 200. On the error screen 1101, a message 1102 is displayed to prompt the user to configure a password to permit access to the remote UI via the operation unit 116 of the MFP 101.

Executing the above-described process prevents unintended users from configuring a password to access a webpage provided by an MFP.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)?), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-171910, filed Oct. 27, 2022, which is hereby incorporated by reference herein in its entirety.

What is claimed is:

1. A non-transitory computer-readable storage medium storing a program for causing an information processing terminal to execute a method comprising:
receiving a plurality of settings including a network setting of an image processing apparatus;
transmitting the received network setting to the image processing apparatus;
receiving, from the image processing apparatus, connection destination information to display a page on which at least a predetermined setting of the image processing apparatus that is different from the plurality of settings is to be configured, the connection destination information being generated based on the transmitted network setting; and
displaying, based on completion of configuration of the plurality of settings, an object to access a connection destination indicated by the received connection destination information.

2. The non-transitory computer-readable storage medium according to claim 1,
wherein in a case where the displayed object is selected, a web browser installed in the information processing terminal is prompted to access the connection destination indicated by the connection destination information, and
wherein the web browser displays a setting screen based on data acquired from the connection destination.

3. The non-transitory computer-readable storage medium according to claim 1, wherein the predetermined setting is a setting related to a scan function of the image processing apparatus.

4. The non-transitory computer-readable storage medium according to claim 1, wherein the object is a button.

5. The non-transitory computer-readable storage medium according to claim 2, wherein the connection destination information is a uniform resource locator (URL) generated by the image processing apparatus and corresponding to the setting screen.

6. The non-transitory computer-readable storage medium according to claim 1, wherein the plurality of settings includes the network setting and a software installation setting.

7. The non-transitory computer-readable storage medium according to claim 1, wherein the object and information prompting access to the connection destination are displayed.

8. The non-transitory computer-readable storage medium according to claim 5, wherein an Internet Protocol (IP) address setting of the image processing apparatus is received as the network setting, and the URL includes the IP address setting.

9. A setting system comprising:
a reception unit configured to receive a plurality of settings including a network setting of an image processing apparatus;
a transmission unit configured to transmit the network setting received by the reception unit to the image processing apparatus;
a receiver unit configured to receive, from the image processing apparatus, connection destination information to display a page on which at least a predetermined setting of the image processing apparatus that is different from the plurality of settings is to be configured, the connection destination information being generated based on the transmitted network setting; and
a display unit configured to display, based on completion of configuration of the plurality of settings, an object to access a connection destination indicated by the received connection destination information.

10. The setting system according to claim 9,
wherein in a case where the object displayed by the display unit is selected, a web browser installed in the information processing terminal is prompted to access the connection destination indicated by the connection destination information, and
wherein the web browser displays a setting screen based on data acquired from the connection destination.

11. The setting system according to claim 9, wherein the predetermined setting is a setting related to a scan function of the image processing apparatus.

12. The setting system according to claim 9, wherein the object is a button.

13. The setting system according to claim 10, wherein the connection destination information is a URL generated by the image processing apparatus and corresponding to the setting screen.

14. The setting system according to claim 9, wherein the plurality of settings includes the network setting and a software installation setting.

15. The setting system according to claim 9, wherein the display unit displays the object and information prompting access to the connection destination.

16. The setting system according to claim 13, wherein the reception unit receives an IP address setting of the image processing apparatus as the network setting, and the URL includes the IP address setting.
